(19) United States
(12) Patent Application Publication
(10) Pub. No.: US 2017/0095919 A1
(43) Pub. Date: Apr. 6, 2017

(54) MAGAZINE STRUCTURE OF WIRE STAPLE PRESS

(71) Applicant: Ton-Yi Chen, Taichung City (TW)

(72) Inventor: Ton-Yi Chen, Taichung City (TW)

(21) Appl. No.: 15/068,646

(22) Filed: Mar. 14, 2016

(30) Foreign Application Priority Data
Oct. 1, 2015 (TW) 104132450

(51) Int. Cl. B25C 5/16

(52) U.S. Cl. CPC B25C 5/1617

(57) ABSTRACT

A magazine structure of a wire staple press is disclosed, which involves an arrangement that a staple receiving compartment of a magazine cartridge forms therein a clamp passage, a first nail passage, and a second nail passage respectively corresponding to a clamp part, a U-shaped nail part, or a T-shaped nail part of a wire staple and the arrangement allows the staple magazine to be used with wire staples having a U-shaped nail part or a T-shaped nail part thereby improving the applicability of the wire staple press and allowing staples of different types to be fed in a stable manner to prevent the staples from curing during a striking operation and thus improving effectiveness and efficiency of operation and the utilization thereof.

### TECHNICAL FIELD OF THE INVENTION

The present invention relates generally to the technical field of wire staple press, and more particularly to a magazine structure of a wire staple press that is applicable to various types of staples in order to the applicability thereof and also enhance the property of positioning in pressing staples thereby improving the operation efficiency and yield rate.

### DESCRIPTION OF THE PRIOR ART

Flexible wires or cables, such as electrical wires, telephone cables, and signal cables, are generally made up of a metallic core covered by an insulation plastic layer. In laying the wires and cables, it is generally hard to effectively fasten the wires and cables along a desired route. Wire staples are commonly used to handle this situation for fastening the wires and cables in position. A wire staple generally comprises a wire clamp part that has a bottom end forming a wire receiving trough and a nail that is mounted to the wire clamp part, wherein the wire receiving trough of the wire clamp part receives and holds a wire or cable therein and the nail is pressed into and fixed to for example a wall. To improve operation efficiency, staple presses dedicated for use with such wire staples. However, wire staples of different sizes must be used to fit to different gauges of wires or cables. Taiwan Utility Model Nos. 537132, M297298, and M404756, disclose different solutions for handling the problem to suit for the needs of different sizes of wire staples.

These staple presses effectively overcome the issue of different sizes of the staples. However, to work with walls of different materials, the staples have two different shapes for the nail part, either a U-shaped or a T-shaped. The U-shaped nail part is applicable to for example a wooden wall of which the material is relatively soft and provides a poor confining force so that two limbs are involved and the limbs have extended length to suit the needs for desired property of anchoring and confining and is generally made of iron of relatively low cost, which has a low strength and is not applicable to walls made of concrete or rocks. As to the T-shaped nail part, which is generally applicable to a concrete or stone wall that is relatively rigid and has a better confining force so that it has a single limb of a relatively short length to suit the desired property of anchoring and confining provided by the concrete wall and is generally made of steel having a relatively high strength and a high cost, making it not fit to make U-shaped nail part for use with wooden walls.

Due to stability of operation that might be achieved, a conventional staple press is only applicable to a wire staple having a U-shaped nail part. A wire staple with a T-shaped nail part must be stricken manually one by one with a hammer and is generally not suit for automatic operations. This causes inconvenience of operation and results in unexpected troubles of work. As such, it is a challenge to provide a solution to overcome such a problem.

### SUMMARY OF THE INVENTION

An object of the present invention is to provide a magazine structure of a wire staple press for use with wire staples having various nail parts in order to improve the applicability of the wire staple press and enhance utilization of the wire staple press.

Another object of the present invention is to provide a magazine structure of a wire staple press that has excellent property of positioning to allow wire staples having different nail parts to be fed and advanced in a stable manner and helps prevent the nail parts from curving during a pressing process thereby improving effectiveness and efficiency of operation.

In view of the above, the present invention provides the following technical measures to achieve the above objects, which comprises:

a press body; and

a staple magazine, which is coupled to an underside of the press body and comprises a magazine cartridge and a staple push member, wherein the magazine cartridge comprises a staple receiving compartment formed therein and extending completely therethrough in a front-rear direction, the magazine cartridge comprising a bottom board mounted to the staple receiving compartment adjacent to a bottom thereof, the staple receiving compartment having a height corresponding to a height of a wire staple having a U-shaped nail part, the staple receiving compartment having a lower section defining a clamp passage that corresponds, in width, to the clamp part of a wire staple, the staple receiving compartment having an upper section defining a first nail passage that corresponds, in width, to the U-shaped nail part of a wire staple, the staple receiving compartment comprising a second nail passage that is formed by recessing opposite side walls of the first nail passage and located between the first nail passage and the clamp passage and corresponding, in width, to a head portion of the T-shaped nail part, a stepped surface being formed between the first nail passage and the second nail passage to receive a top end of the head portion of the T-shaped nail part to abut thereon.

As such, the present invention provides a wire staple press that involves an arrangement that a staple receiving compartment of a magazine cartridge of a staple magazine forms therein a clamp passage, a first nail passage, and a second nail passage respectively corresponding to a clamp part, a U-shaped nail part, or a T-shaped nail part of a wire staple and the arrangement allows the staple magazine to be used with wire staples having a U-shaped nail part or a T-shaped nail part thereby improving the applicability of the wire staple press and allowing staples of different types to be fed in a stable manner to prevent the staples from curing during a striking operation and thus improving effectiveness and efficiency of operation and the utilization thereof In this way, added value is greatly increased and thus the economic benefit is enhanced.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention.

FIG. 2 is an exploded view of the present invention.

FIG. 3 is an end view of the preferred embodiment.

FIG. 4 is a cross-sectional view illustrating a preferred embodiment of the present invention, in which part (A) illustrates an application to a staple wire having a U-shaped nail part and part (B) illustrates an application to a staple wire having a T-shaped nail part.

FIG. 5 is a cross-sectional view illustrating another embodiment of the present invention, in which part (A) illustrates an application to a staple wire having a U-shaped nail part and part (B) illustrates an application to a staple wire having a T-shaped nail part.

FIG. 6 is an exploded view illustrating a further preferred embodiment of the present invention.

FIG. 7 is an end view of the embodiment of FIG. 6.

FIG. 8 is a cross-sectional view of the embodiment of FIG. 6, in which part (A) illustrates an application to a staple wire having a U-shaped nail part and part (B) illustrates an application to a staple wire having a T-shaped nail part.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

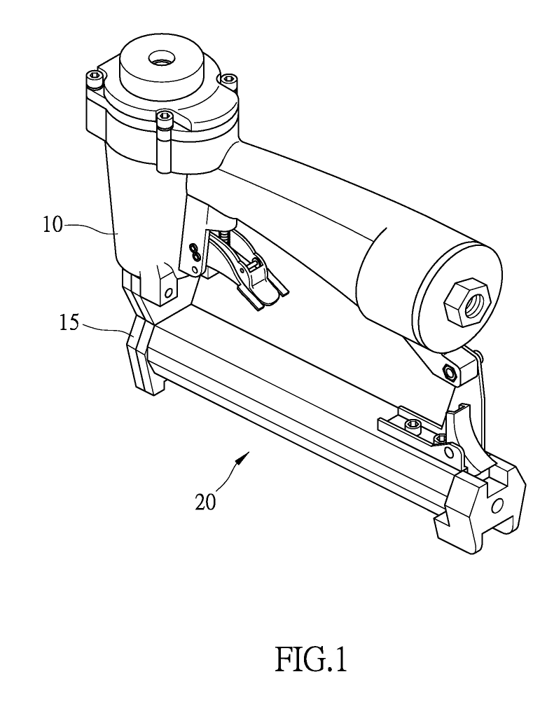

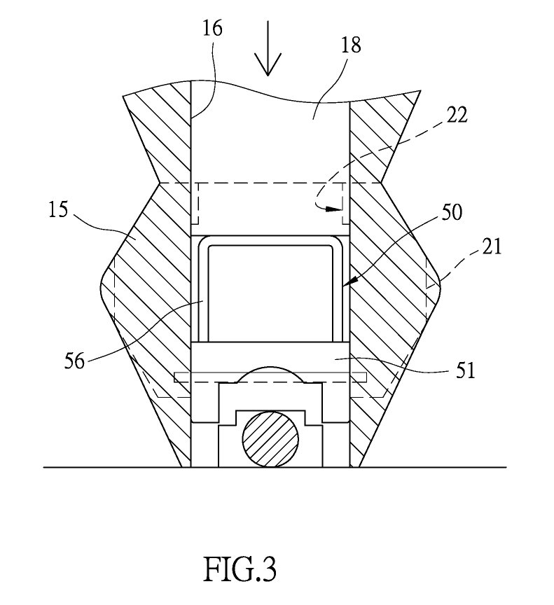

The present invention provides a magazine structure of a wire staple press as shown in FIGS. 1, 2, and 3. The wire staple press comprises a press body 10 and a staple magazine 20 mounted to a bottom of the press body 10. The press body 10 has a front end to which a staple striking seat 15 is mounted and is coupled to a front end of the staple magazine 20. The staple striking seat 15 comprises a striking channel 16 formed therein and in communication with the staple magazine 20 to allow a wire staple 50 to be forcibly stricken out by a strike plate 18 that is driven by the press body 10. The wire staple 50 comprises a clamp part 51 that functions to clamp and fix a wire. The clamp part 51 is provided thereon with a U-shaped nail part 56 that has an expanded height or a T-shaped nail part 57 that has a reduced height for fixing and anchoring the wire staple 50 to a fixture, such as a wall surface. The striking operation of the press body 10 is similar to that of the conventional staple presses and constitutes no novel part of the present invention, so that further detail will be omitted herein.

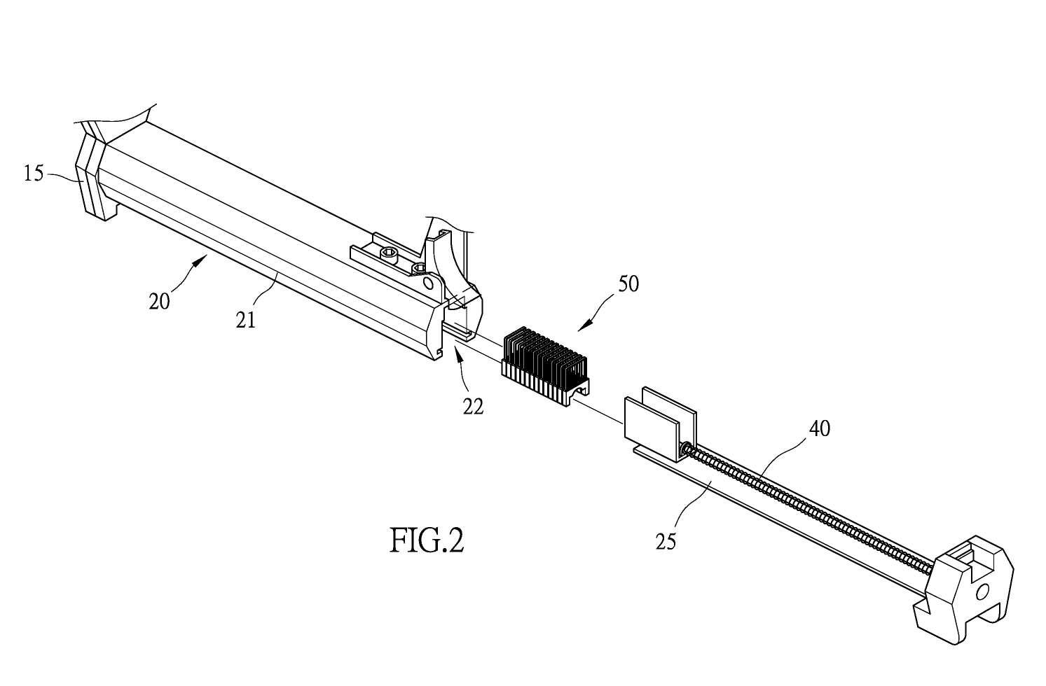

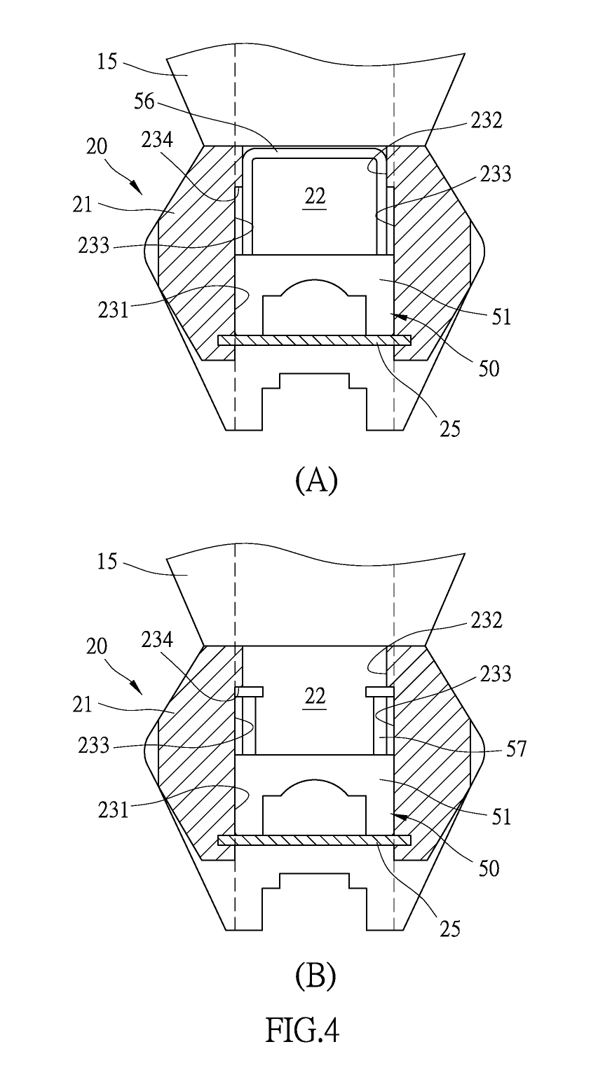

The staple magazine 20 of the present invention is more clearly shown in FIGS. 2, 3, and 4. The staple magazine 20 comprises a magazine cartridge 21 and a staple push member 40. The magazine cartridge 21 comprises a staple receiving compartment 22 formed therein to extend completely therethrough in a front-rear direction. The magazine cartridge 21 comprises a removable (see FIG. 2) or integrally formed bottom board 25 mounted to the staple receiving compartment 22 at a location adjacent to a bottom thereof to provide a bottom-loading wire staple press. The staple receiving compartment 22 has a height that corresponds to a height of the wire staple 50 with the U-shaped nail part 56. The staple receiving compartment 22 has a lower section that defines a clamp passage 231 corresponding, in width, to the clamp part 51 of the wire staple 50. The staple receiving compartment 22 has an upper section that forms a first nail passage 232 that corresponds, in width, to the U-shaped nail part 56 of the wire staple 50. The staple receiving compartment 22 of the magazine cartridge 21 has a top end face that allows a top end of the U-shaped nail part 56 to abut thereon, as shown in FIG. 4A, to improve stability of feeding the wire staple 50 with the U-shaped nail part 56. Opposite side walls of the first nail passage 232 of the staple receiving compartment 22 are recessed to define a second nail passage 233 located between the first nail passage 232 and the clamp passage 231 and having an expanded width corresponding to a width of a head portion of the T-shaped nail part 57 and a stepped surface 234 (see FIG. 4B) is formed between the first nail passage 232 and the second nail passage 233 to allow a top end of the head portion of the T-shaped nail part 57 to abut thereon for improving stability of feeding the wire staple 50 having the T-shaped nail part 57.

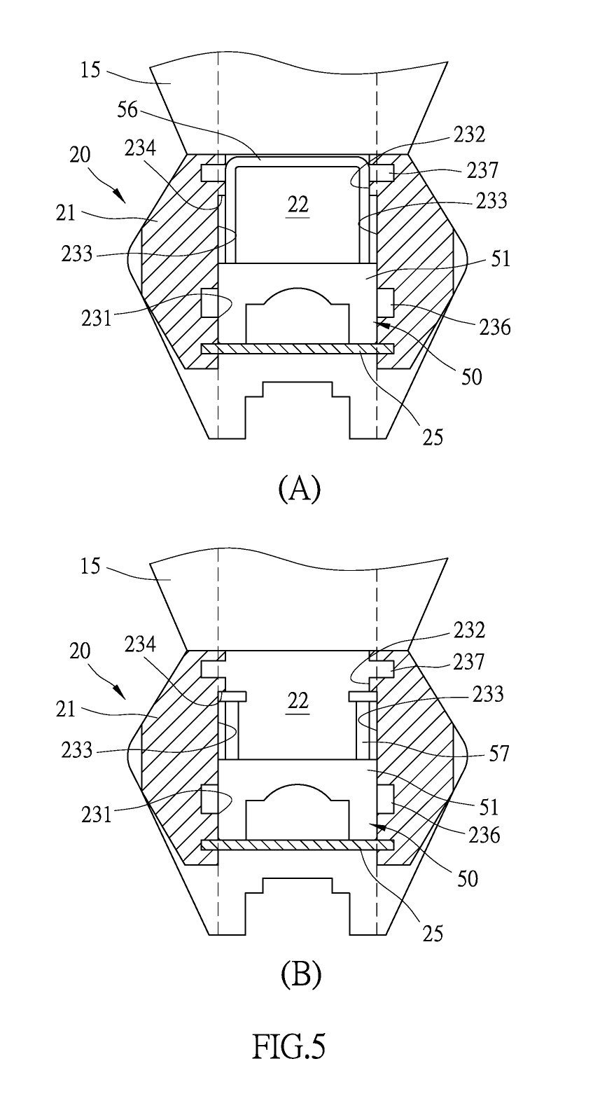

Another embodiment of the staple magazine 20 according to the present invention is shown in FIG. 5. The magazine cartridge 21 of the staple magazine 20 comprises a first avoidance groove 236 formed in each of two opposite side walls of the clamp passage 231 of the staple receiving compartment 22 and also comprises a second avoidance groove 237 formed in each of two opposite side walls of the first nail passage 232 of the U-shaped nail part 56 to reduce the amount of material used and also to reduce a frictional force induced between the wire staple 50 having the U-shaped nail part 56 and the staple receiving compartment 22 of the magazine cartridge 21 to make the feeding of the wire staple 50 stable and smooth.

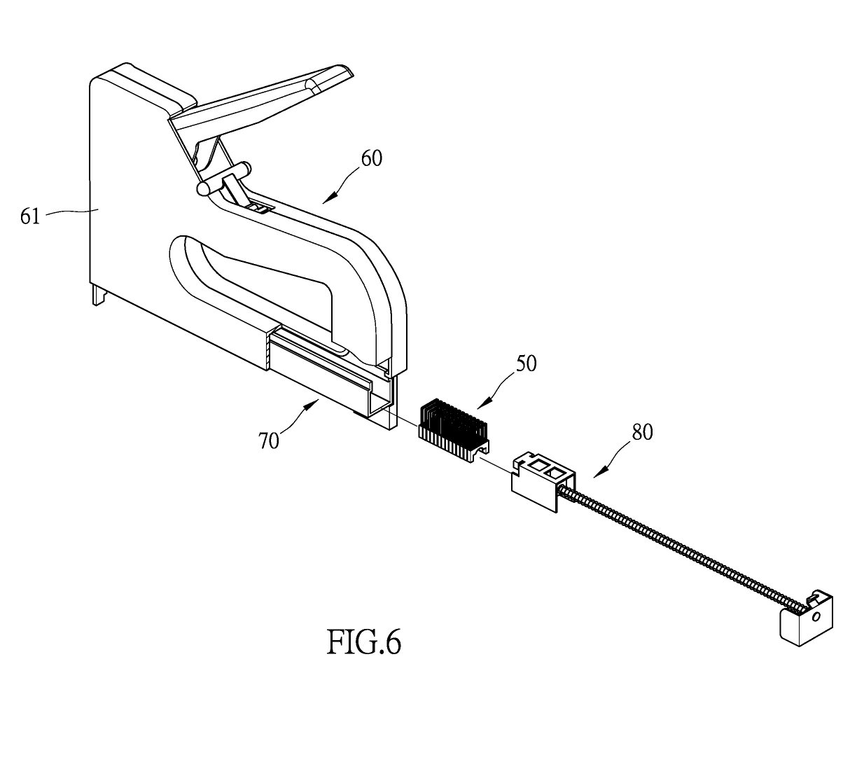

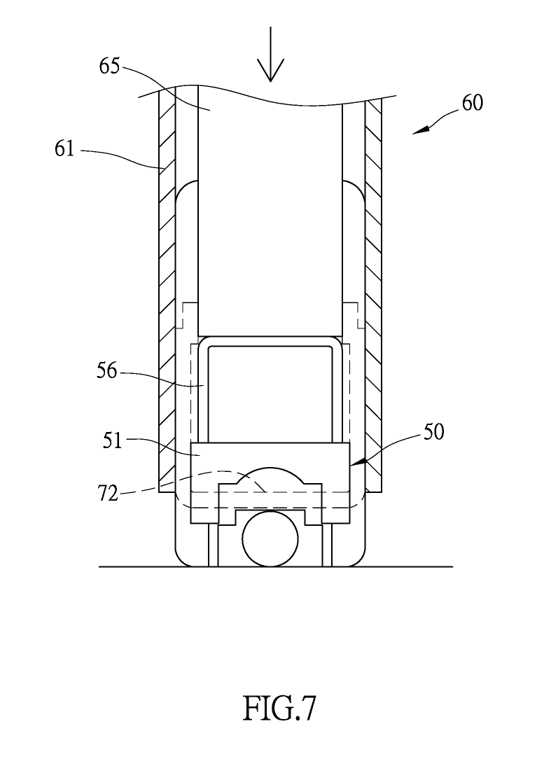

Further, another embodiment of the wire staple press according to the present invention is shown in FIGS. 6, 7, and 8, which is a manual operation wire staple press. The wire staple press comprises a press body 60 that is formed by mating two opposite side covers 61 with each other and a staple magazine 70 that is formed by for example stamping a plate and is mounted to a bottom of the two mated side covers 61 of the press body 60. The staple magazine 70 comprises a staple push member 80 arranged therein for automatically advancing the wire staple 50. This arrangement provides a rear-loading wire staple press. The press body 60 has a front end to which a strike plate 65 is movably mounted to be driven to forcibly strike a wire staple 50 out. The striking operation of the press body 60 is similar to that of the conventional staple presses and constitutes no novel part of the present invention, so that further detail will be omitted herein.

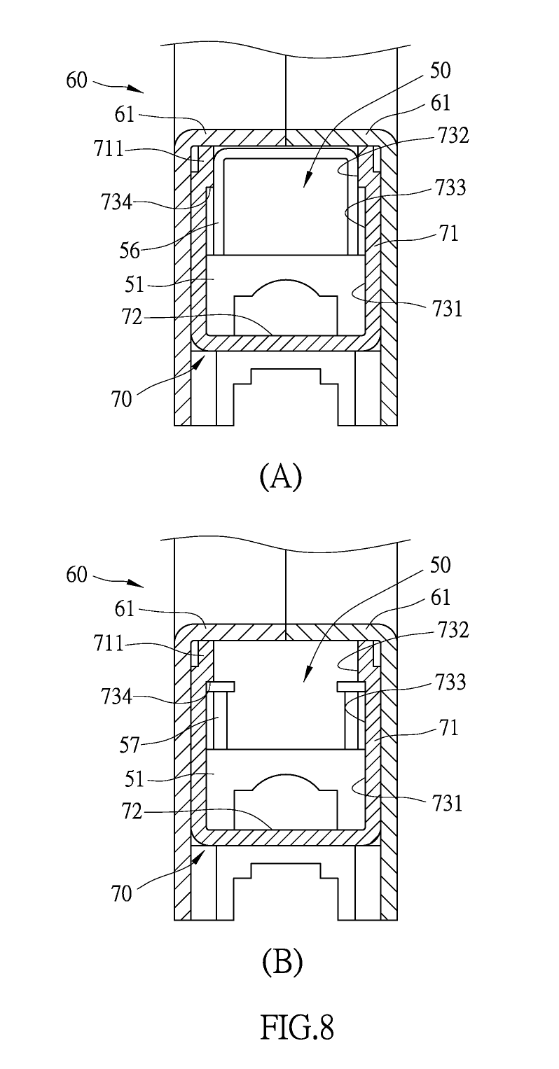

The novel feature provided in the present invention is illustrated in FIG. 8, wherein the staple magazine 70 comprises a U-shaped magazine cartridge 71 that is received between the two side covers 61. The U-shaped magazine cartridge 71 comprises a staple receiving compartment 72 formed therein to extend completely therethrough in a front-rear direction. The staple receiving compartment 72 has a height that corresponds to a height of the wire staple 50 with the U-shaped nail part 56. The staple receiving compartment 72 has a lower section that defines a clamp passage 731 corresponding, in width, to the clamp part 51 of the wire staple 50. The staple receiving compartment 72 has two opposite side walls each having an upper section that is bent inward to form a sideway shifted section 711, so that the staple receiving compartment 72 of the U-shaped magazine cartridge 71 forms, in an upper section thereof, a first nail passage 732 that corresponds, in width, to the U-shaped nail part 56 of the wire staple 50. A top part of the side covers 61 located on the staple receiving compartment 72 of the U-shaped magazine cartridge 71 allows a top end of the U-shaped nail part 56 to abut thereon, as shown in FIG. 8A, to improve stability of feeding the wire staple 50 with the U-shaped nail part 56. Opposite side walls of the first nail passage 732 of the staple receiving compartment 72 are recessed to define a second nail passage 733 located between the first nail passage 732 and the clamp passage 731 and having an expanded width corresponding to a width of a head portion of the T-shaped nail part 57 and a stepped surface 734 (see FIG. 8B) is formed between the first nail passage 732 and the second nail passage 733 to allow a top end of the head portion of the T-shaped nail part 57 to abut thereon for improving stability of feeding the wire staple 50 having the T-shaped nail part 57.

The above illustrates the wire staple press of the present invention involves an arrangement that the staple receiving compartment 22, 72 of the magazine cartridge 21 or the U-shaped magazine cartridge 71 of the staple magazine 20, 70 forms therein a clamp passage 231, 731, a first nail passage 232, 732, and a second nail passage 233, 733 respectively corresponding to a clamp part 51, a U-shaped nail part 56, or a T-shaped nail part 57 of a wire staple 50 and the arrangement allows the staple magazine 20, 70 to be used with wire staples 50 having a U-shaped nail part 56 or a T-shaped nail part 57 thereby improving the applicability of the wire staple press and allowing staples of different types to be fed in a stable manner to prevent the staples from curing during a striking operation and thus improving effectiveness and efficiency of operation and the utilization thereof

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A wire staple press for pressing a wire staple having a clamp part that is provided with a U-shaped nail part or a T-shaped nail part and comprising:
a press body; and
a staple magazine, which is coupled to an underside of the press body and comprises a magazine cartridge and a staple push member, wherein the magazine cartridge comprises a staple receiving compartment formed therein and extending completely therethrough in a front-rear direction, the magazine cartridge comprising a bottom board mounted to the staple receiving compartment adjacent to a bottom thereof, the staple receiving compartment having a height corresponding to a height of a wire staple having a U-shaped nail part, the staple receiving compartment having a lower section defining a clamp passage that corresponds, in width, to the clamp part of a wire staple, the staple receiving compartment having an upper section defining a first nail passage that corresponds, in width, to the U-shaped nail part of a wire staple, the staple receiving compartment comprising a second nail passage that is formed by recessing opposite side walls of the first nail passage and located between the first nail passage and the clamp passage and corresponding, in width, to a head portion of the T-shaped nail part, a stepped surface being formed between the first nail passage and the second nail passage to receive a top end of the head portion of the T-shaped nail part to abut thereon.

2. The wire staple press according to claim 1, wherein the magazine cartridge comprises a first avoidance groove formed in each of opposite side walls of the clamp passage of the staple receiving compartment and also comprises a second avoidance groove formed in each of opposite side walls of the first nail passage that corresponds to the U-shaped nail part.

3. A wire staple press for pressing a wire staple having a clamp part that is provided with a U-shaped nail part or a T-shaped nail part and comprising:
a press body, which has a housing that is formed by mating two opposite side covers; and
a staple magazine, which is mounted to an underside of the two mated side covers of the press body, which comprises a U-shaped magazine cartridge formed by stamping a plate and a staple push member, the U-shaped magazine cartridge comprising a staple receiving compartment formed therein to extend completely therethrough in a front-rear direction, the staple receiving compartment having a height corresponding to a height of a wire staple having a U-shaped nail part, the staple receiving compartment having a lower section that defines a clamp passage corresponding, in width, to the clamp part of a wire staple, the staple receiving compartment having two opposite side walls each having an upper section that is bent inward to form a sideway shifted section, so that the staple receiving compartment forms, in an upper section thereof, a first nail passage that corresponds, in width, to the U-shaped nail part of a wire staple, the staple receiving compartment comprising a second nail passage that is formed by recessing opposite side walls of the first nail passage and is located between the first nail passage and the clamp passage and corresponding, in width, to a head portion of the T-shaped nail part, a stepped surface being formed between the first nail passage and the second nail passage to allow a top end of the head portion of the T-shaped nail part to abut thereon.
